(19) United States
(12) Patent Application Publication
(10) Pub. No.: US 2010/0161678 A1
(43) Pub. Date: Jun. 24, 2010

(54) METHOD AND APPARATUS FOR UTILIZING MATLAB FUNCTIONALITY IN JAVA-ENABLED ENVIRONMENT

(75) Inventors: Vidhyashankaran Ramamoorthy Iyer, Bangalore (IN); Dinkar Mylaraswamy, Fridley, MN (US); Sunil Menon, Scottsdale, AZ (US); Emmanuel Obiesie Nwadiogbu, Scottsdale, AZ (US); Jijji Ramanathan, Bangalore (IN)

Correspondence Address: HONEYWELL/IFL;Patent Services, 101 Columbia Road, P.O.Box 2245, Morristown, NJ, 07962-2245, US

(73) Assignee: Honeywell International Inc., Morristown, NJ (US)

(21) Appl. No.: 12/342,497

(22) Filed: Dec. 23, 2008

(51) Int. Cl. G06F 7/00

(52) U.S. Cl. 707/802; 707/E17.006; 707/E17.055

(57) ABSTRACT

A Java-MATLAB bridge is provided for enabling utilization of MATLAB® functionality in an enterprise environment. The Java-MATLAB bridge includes a Java® wrapper and a MATLAB wrapper. The MATLAB wrapper is coupled to the Java wrapper and the Java wrapper provides an entry point for invoking the MATLAB functionality in the enterprise environment.

### FIELD OF THE INVENTION

The present invention generally relates to data processing in a Java-enabled environment and, more particularly relates to a method and apparatus for utilizing MATLAB data processing functionality in an Java-enabled environment.

### BACKGROUND OF THE INVENTION

MATLAB® is a numerical computing environment and programming language which provides advanced algorithms for allowing easy matrix manipulation, plotting of functions and data, creation of user interfaces and interfacing with other languages. Many large data processing systems, such as an enterprise based data processing system, are typically enabled by Java®, a programming language similar to C or C++ programming languages but having a simpler object model and fewer low-level facilities than C or C++. An enterprise environment includes an enterprise service bus to allow intelligent diagnostic and/or prognostic monitoring of, for example, a plurality of vehicle systems such as systems in one or more aircrafts, automobiles or trains and is typically Java-enabled to provide the advantages of Java data handling. However, being Java-enabled, the enterprise environment is incapable of utilizing the advanced functionality provided by MATLAB to handle and process data.

Thus, what is needed is a method and apparatus for utilizing MATLAB data processing functionality in Java-enabled environment. Furthermore, other desirable features and characteristics of the present invention will become apparent from the subsequent detailed description of the invention and the appended claims, taken in conjunction with the accompanying drawings and this background of the invention.

### BRIEF SUMMARY OF THE INVENTION

A method is provided for invoking MATLAB® format algorithms in a Java-enabled enterprise environment. The method includes the steps of a Java® Wrapper and a MATLAB Wrapper handshaking to establish communication therebetween and, thereafter, the Java Wrapper converting data from a Java object to a MATLAB structure.

In addition, a Java-MATLAB bridge is provided for enabling utilization of MATLAB® functionality in an enterprise environment. The Java-MATLAB bridge includes a Java® wrapper and a MATLAB wrapper. The MATLAB wrapper is coupled to the Java wrapper and the Java wrapper provides an entry point for invoking the MATLAB functionality in the enterprise environment.

Further, an enterprise based data processing system is provided for handling data. The enterprise based data processing system includes an enterprise service bus, a processing manager, and an equipment model database. The enterprise service bus communicates data within the enterprise based data processing system. The processing manager is coupled to the enterprise service bus and provides data thereto and receives data therefrom. The equipment model database is coupled to the processing manager for receiving output data therefrom and generating engineering data in response thereto. The equipment model database also generates processable data from engineering data received thereby and provides the processable data to the processing manager. The processing manager includes a Java-MATLAB bridge which includes a Java® wrapper for providing an entry point from the enterprise service bus for invoking MATLAB® functionality in the enterprise based data processing system.

### BRIEF DESCRIPTION OF THE DRAWINGS

The present invention will hereinafter be described in conjunction with the following drawing figures, wherein like numerals denote like elements, and

FIG. 1 illustrates a block diagram of an enterprise based data processing system in accordance with the present embodiment;

FIG. 2 illustrates a block diagram of processing manager of the enterprise based data processing system of FIG. 1 in accordance with the present embodiment; and

FIG. 3 illustrates a Java-MATLAB bridge for enabling utilization of MATLAB® functionality in the processing manager of FIG. 2 in accordance with the present embodiment.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

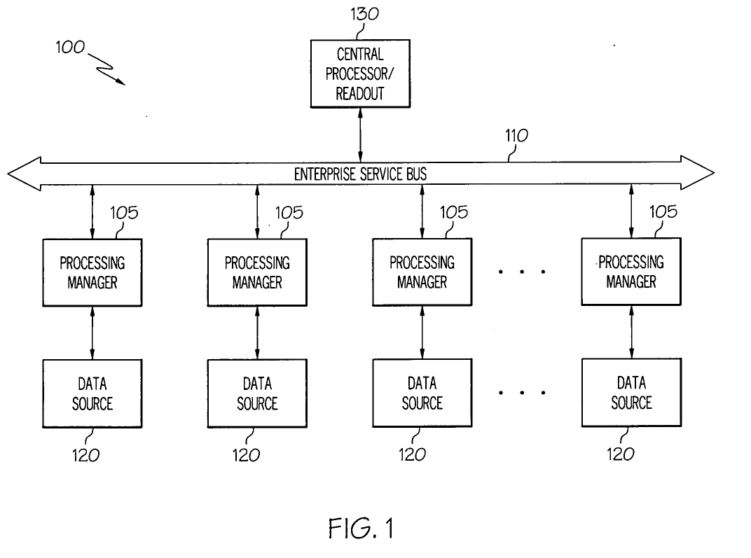

Referring to FIG. 1, an enterprise based data processing system 100 includes a plurality of processing managers 105 coupled to an enterprise service bus 110. The processing managers 105 receive and/or review data from data sources 120 and provides information to a central processor/readout 130 via the enterprise service bus 110 for operational support of the enterprise based data processing system 100.

The enterprise based data processing system 100 allows free exchange and monitoring of data and could enable diagnostic and/or prognostic monitoring of a large number of data sources 120 via the plurality of processing managers 105. For example, a plurality of vehicle systems such as systems in one or more aircrafts, automobiles or trains can be managed and/or monitored by the enterprise based data processing system 100 wherein each of the processing managers 105 manages or monitors a particular sub-system of the plurality of vehicle systems. For example, the enterprise based data processing system 100 could comprise an aircraft operational support system wherein the processing managers 105 include an aircraft propulsion diagnostics and prognostics manager, an aircraft engine control system diagnostics and prognostics manager, an aircraft auxiliary power unit diagnostics and prognostics manager, and an aircraft fault model (for example, pertaining to a flight management system, flight control actuators, landing systems, and the like). In a similar manner, the enterprise based data processing system 100 could comprise an automobile operational support system wherein the processing managers 105 manage and/or monitor automobile sub-systems such as the automobile's air conditioning system.

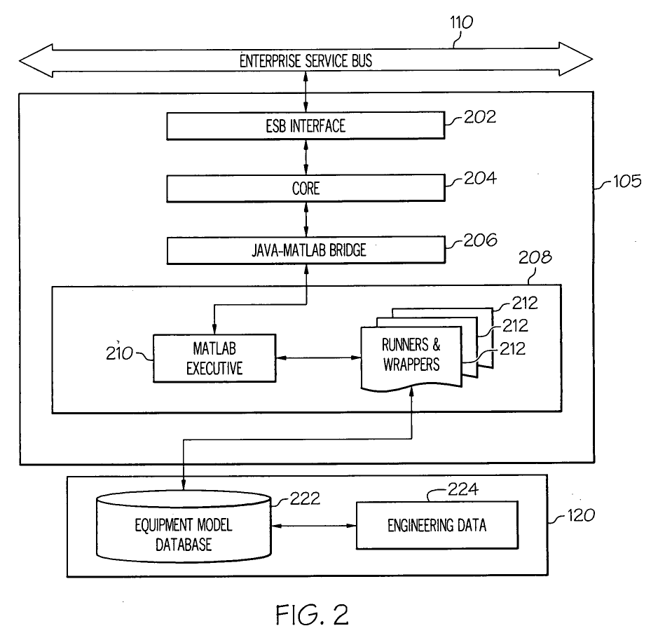

Referring to FIG. 2, a more detailed block diagram of one of the processing managers 105 in accordance with the present embodiment is depicted. The processing manager 105 is coupled to the enterprise service bus 110 for communication within the enterprise based data processing system 100 via an enterprise service bus (ESB) interface 202. The ESB interface 202 receives information from the enterprise service bus 110 and passes it to a processing core 204 for handling in accordance with the function of the processing manger 105. The processing core 204 also passes information to the ESB interface 202 for providing to the enterprise based data processing system 100 via the enterprise service bus 110.

The enterprise based data processing system 100 is Java-enabled and, accordingly, the processing core 204 operates in the Java language. In accordance with the present embodiment, the processing manager 105 also utilizes MATLAB language functionality for handling data from the data source 120. The processing core 204 is coupled to a Java-MATLAB bridge 206 which converts Java operation to MATLAB operation when data and/or commands are passed from the processing core 204 to the data source 120. The Java-MATLAB bridge 206 also converts MATLAB operation to Java operation when data and/or commands are passed from the data source 120 to the processing core 204. In accordance with the present embodiment, the Java-MATLAB bridge 206 includes a Java wrapper for providing an entry point from the enterprise service bus 110 for invoking MATLAB functionality in the enterprise based data processing system 100.

The processing manager 105 also includes an algorithmic functional subsystem 208 connected to the Java-MATLAB bridge for receiving unmarshalled MATLAB structure data therefrom, the algorithmic functional subsystem 208 including a MATLAB executive 210 for controlling performance of the MATLAB functionality on the unmarshalled MATLAB structure data and one or more MATLAB runners and wrappers 212 for handling the MATLAB data during performance of the MATLAB functionality. The MATLAB runners and wrappers communicate with the data source 120 for retrieval of data therefrom.

The data source 120 receives engineering data 224, such as a measurement of a particular vehicle parameter which is gauged against operational parameter data in an equipment model database 222 to generate processable data, the processable data provided to the algorithmic functional subsystem 208 in the MATLAB runners and wrappers 212. The MATLAB functionality in the MATLAB executive 210 includes underlying MATLAB algorithms. The MATLAB executive 210 executes any assigned MATLAB operations enabled by the underlying MATLAB algorithms on the processable data, thereby transforming the processable data to derive transformed data. After the MATLAB executive 210 derives the transformed data, the Java-MATLAB bridge 206 converts the results to the Java language before providing the data in Java wrappers to the processing core 204.

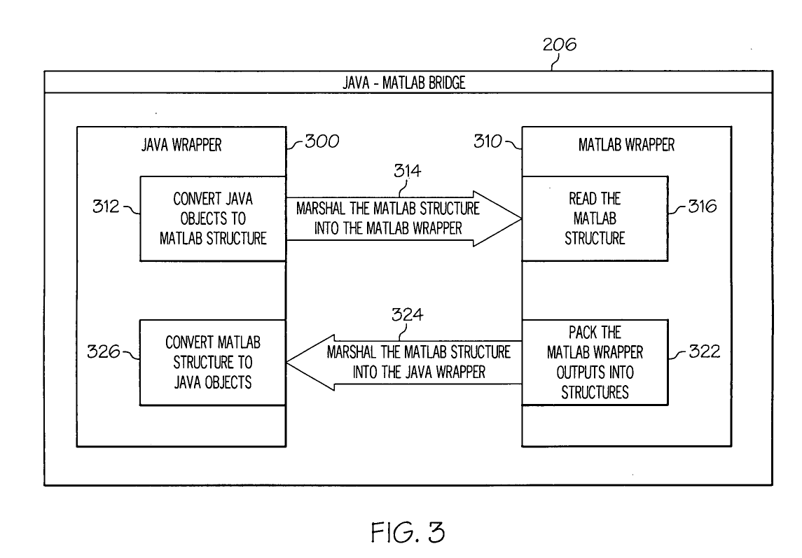

In accordance with the present embodiment, MATLAB functionality is enabled in a Java environment by the Java-MATLAB bridge 206. A functional diagram of the operation of the Java-MATLAB bridge 206 is depicted in FIG. 3. When data and/or commands are being passed from the processing core 204 to the MATLAB executive 210, the data and/or command is transformed from a Java wrapper 300 to a MATLAB wrapper 310. First, the Java objects in the Java wrapper 300 are converted 312 to equivalent MATLAB structures. Then, the MATLAB structures are marshaled 314 into the MATLAB wrapper 310. The MATLAB wrapper 310 enables reading 316 of the MATLAB structure for performance of MATLAB functionality by the MATLAB executive 210 (FIG. 2).

In a similar manner, when the MATLAB executive 210 provides data, such as processable data, and/or commands to the Java-MATLAB bridge 206 in the MATLAB wrapper 310, the MATLAB wrapper 310 outputs are packed 322 into MATLAB structures. The MATLAB structures are then marshaled 324 into the Java wrapper 300 and the Java wrapper 300 converts the MATLAB structure to equivalent Java objects. In this manner, the Java wrapper 300 provides an entry point for invoking the MATLAB functionality in the enterprise based data processing system 100.

Thus it can be seen that a method and apparatus for utilizing MATLAB data processing functionality in Java-enabled environment has been provided. While at least one exemplary embodiment has been presented in the foregoing detailed description of the invention, it should be appreciated that a vast number of variations exist. It should also be appreciated that the exemplary embodiment is only one example and is not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in the exemplary embodiment without departing from the scope of the invention as set forth in the appended claims.

What is claimed is:

1. An enterprise based data processing system comprising:
an enterprise service bus for communicating data within the enterprise based data processing system;
a processing manager coupled to the enterprise service bus for providing data thereto and receiving data therefrom; and
an equipment model database coupled to the processing manager for receiving output data therefrom and generating engineering data in response thereto, the equipment model database also generating processable data from engineering data received thereby and providing the processable data to the processing manager,
wherein the processing manager comprises a Java-MATLAB bridge including a Java® wrapper for providing an entry point from the enterprise service bus for invoking MATLAB® functionality comprising diagnostics and prognostics algorithms in the enterprise based data processing system.

2. The enterprise based data processing system in accordance with claim 1 wherein the processing manager further comprises:
an enterprise service bus interface connected to the enterprise service bus for receiving data therefrom and for providing data thereto; and
an algorithmic functional subsystem connected to the Java-MATLAB bridge for receiving unmarshalled MATLAB structure data therefrom for performing the MATLAB functionality thereon, the algorithmic functional subsystem coupled to the equipment model database for also receiving data therefrom for performing the MATLAB functionality thereon.

3. The enterprise based data processing system in accordance with claim 2 wherein the algorithmic functional subsystem comprises:
a MATLAB executive module for controlling performance of the MATLAB functionality; and
one or more MATLAB wrappers for handling the data during performance of the MATLAB functionality.

4. The enterprise based data processing system in accordance with claim 1 wherein the Java wrapper of the Java-MATLAB bridge receives data as a Java object and converts the data to an equivalent MATLAB structure.

5. The enterprise based data processing system in accordance with claim 4 wherein the Java-MATLAB bridge comprises a MATLAB wrapper coupled to the Java wrapper, and wherein the Java wrapper marshals the MATLAB structure into the MATLAB wrapper

6. The enterprise based data processing system in accordance with claim 5 wherein the MATLAB wrapper unmarshals the MATLAB structure received from the Java wrapper to derive the unmarshalled MATLAB structure data therefrom, the MATLAB wrapper connected to the algorithmic functional subsystem for providing the unmarshalled MATLAB structure data thereto, the MATLAB wrapper further constructing a MATLAB output structure in response to output data received from the algorithmic functional subsystem and marshalling the MATLAB output structure to the Java wrapper.

7. The enterprise based data processing system in accordance with claim 6 wherein the Java wrapper unmarshals the MATLAB output structure and converts the MATLAB output structure to equivalent Java object data.

8. A Java-MATLAB bridge for enabling utilization of MATLAB® functionality in an enterprise environment, the Java-MATLAB bridge comprising:
a Java® wrapper; and
a MATLAB wrapper coupled to the Java wrapper, wherein the Java wrapper provides an entry point for invoking the MATLAB functionality in the enterprise environment.

9. The Java-MATLAB bridge in accordance with claim 8, wherein the Java wrapper receives data as a Java object and converts the data to an equivalent MATLAB structure.

10. The Java-MATLAB bridge in accordance with claim 9, wherein the Java wrapper further marshals the MATLAB structure into the MATLAB wrapper.

11. The Java-MATLAB bridge in accordance with claim 10, wherein the MATLAB wrapper unmarshals the MATLAB structure to derive the data therefrom, the MATLAB wrapper providing the data to the MATLAB functionality for transformation of the data to derive transformed data.

12. The Java-MATLAB bridge in accordance with claim 11 wherein the MATLAB functionality comprises underlying MATLAB algorithms, and wherein the underlying MATLAB algorithms transform the data to derive the transformed data.

13. The Java-MATLAB bridge in accordance with claim 11, wherein the MATLAB wrapper further constructs a MATLAB output structure based on the transformed data.

14. The Java-MATLAB bridge in accordance with claim 13, wherein the MATLAB wrapper further marshals the MATLAB output structure to the Java wrapper.

15. The Java-MATLAB bridge in accordance with claim 14, wherein the Java wrapper unmarshals the MATLAB output structure and converts the MATLAB output structure to equivalent Java object data.

16. A method for invoking MATLAB® format algorithms in a Java-enabled enterprise environment, the method comprising the steps of:
a Java® Wrapper and a MATLAB Wrapper handshaking to establish communication therebetween; and
the Java Wrapper converting data from a Java object to a MATLAB structure.

17. The method in accordance with claim 16 further comprising the step of the Java Wrapper marshalling the MATLAB structure into the MATLAB Wrapper.

18. The method in accordance with claim 17 further comprising the steps of:
the MATLAB Wrapper extracting the data from the MATLAB structure; and
the MATLAB Wrapper performing MATLAB algorithm on the data to generate output data.

19. The method in accordance with claim 18 further comprising the steps of:
the MATLAB Wrapper packing the output data into MATLAB structures; and
the MATLAB Wrapper marshalling the MATLAB structures into the Java Wrapper.

20. The method in accordance with claim 19 further comprising the step of the Java Wrapper converting the MATLAB structures to Java objects.
